(19) United States
(12) Patent Application Publication
(10) Pub. No.: US 2011/0006563 A1
(43) Pub. Date: Jan. 13, 2011

(54) GLASS HEIGHT ADJUSTER FOR SUNROOF ASSEMBLY

(75) Inventors: Tim Panther, Washington Township, MI (US); Andrew Petty, Linden, MI (US); Brian Drotar, Royal Oak, MI (US)

Correspondence Address: FITCH, EVEN, TABIN & FLANNERY, P. O. BOX 18415, WASHINGTON, DC, 20036, US

(73) Assignee: WEBASTO AG, Stockdorf (DE)

(21) Appl. No.: 12/818,076

(22) Filed: Jun. 17, 2010

Related U.S. Application Data
(60) Provisional application No. 61/225,001, filed on Jul. 13, 2009.

(51) Int. Cl. B60J 7/043

(52) U.S. Cl. 296/216.08

(57) ABSTRACT

A glass height adjuster for a sunroof assembly using a mounting bracket extension adapter. The present invention can include an extension adapter having a countersunk first opening on the lower portion, a second opening in the upper portion spaced a predetermined distance from the first opening to compensate for a vertical variance of the mounted movable surface to a vehicle roof; and the bracket configured to be placed and attached between a sunroof mounting bracket and a sunroof mechanism arm, whereby function of the movable surface is maintained. Additional features can include a lip on a lower edge to conform to a lower edge of the mechanism arm, or a tab to retain the mechanism arm from a first and second side of the mechanism arm.

### FIELD OF THE INVENTION

The present invention generally relates to sunroof assemblies, and particularly to a sunroof mounting bracket extender to allow greater flexibility of glass height adjustment relative to a sunroof mechanism during installation.

### BACKGROUND OF INVENTION

In the art, sunroofs and other movable surfaces installed in an opening of a vehicle roof are well known. Through the years, sunroofs have typically been custom developed for a particular vehicle. Also, various mechanisms have been developed to allow a movable and tiltable and glass panel or panels. These mechanisms also necessitated the need to develop collateral features such as sun shades, frames to maintain vehicle integrity, weather seals, and wind and water management systems. Collectively all these components can be assembled into a manufactured sunroof module. Again, these features often require customization to particular vehicle applications. Customization adds to the cost of a sunroof system and ultimately to the cost of a vehicle. A sunroof manufacturer or distributor also carries the cost of a large inventory of parts, which increases up-front expenses and an increased storage space requirement. Further, a custom sunroof application takes time to develop and manufacture, adding delay to implementation and overall cost.

Traditionally, sunroof assemblies allow for small vertical adjustments of the position of the movable panel (e.g., the glass) relative to the sunroof assembly frame. This adjustment can compensate for minor installation variations, vehicle roof sweep (i.e., curve) variations, or glass panel sweep variations. This can allow an installer to ensure the edge of the glass is flush with the adjacent roof, thus providing a more aerodynamic and aesthetic appearance.

While minor vertical adjustments to sunroof glass relative to its frame show advances in the art, further improvements are possible and desired. In some applications the variation of a vehicle sunroof sweep and the variation of the sweep of a sunroof module are so great that an adjustment to vertical aspect of the sunroof glass panel cannot compensate for the difference. A greater range of adjustment could thus allow application of a single sunroof assembly to a greater range of vehicle applications and vehicle sweeps.

### SUMMARY OF INVENTION

Accordingly, the present invention provides a glass height adjuster for a sunroof assembly. The present invention can be practiced by providing a sunroof mounting bracket extension adapter. This allows greater flexibility of vertical sunroof adjustment relative to a sunroof mechanism during installation. The present invention allows application of a single sunroof assembly to a greater range of vehicle applications and a greater range of vehicle roof sweeps (curves).

In one embodiment, the present invention has a movable surface (such as a sunroof) extension adapter, having a countersunk first opening on the lower portion, a second opening in the upper portion spaced a predetermined distance from the first opening to compensate for a vertical variance of the mounted movable surface to a vehicle roof; and the bracket configured to be placed and attached between a sunroof mounting bracket and a sunroof mechanism arm, whereby full function of the movable surface is maintained. The predetermined distance can be 10 mm.

Additional features of the present invention can include a lip on a lower edge to conform to a lower edge of the mechanism arm, or a tab to retain the mechanism arm from a first and second side of the mechanism arm. Or, the lower portion can have a distal edge that conforms to the contour of the mechanism arm.

The present invention can also be a method of flushing out a movable surface to an adjacent opening of a top edge of a vehicle roof, including attaching a sunroof module to the roof by attaching a module mounting pin to a roof bracket, the sunroof module having a movable surface attached to a bracket, which is attached to a mechanism arm slidably retained within a module sliding track; measuring a vertical distance of the movable surface beneath the roof top edge; and inserting an extension adapter between the bracket and the mechanism arm, the extension adapter having a front side, a back side, an upper portion, and a lower portion, a countersunk first opening on the lower portion, a second opening in the upper portion spaced the vertical distance from the first opening to compensate, whereby full function of the movable surface is maintained. The measuring of the vertical distance can be accurate to +/−2 mm.

Other features of the present invention will become more apparent to persons having ordinary skill in the art to which the present invention pertains from the following description and claims.

### BRIEF DESCRIPTION OF THE FIGURES

The foregoing features, as well as other features, will become apparent with reference to the description and figures below, in which like numerals represent elements and in which:

FIG. 1 illustrates an extension adapter according to the present invention in an exploded view of a sunroof mechanism arm.

FIG. 2 illustrates an extension adapter according to the present invention in a perspective view of a sunroof mechanism arm.

FIG. 3 illustrates an extension adapter according to the present invention in a reverse angle perspective view of a sunroof mechanism arm.

FIG. 4 illustrates an extension adapter according to the present invention in a forward facing perspective view of a sunroof installed in a vehicle.

FIG. 5 illustrates a cross sectional view of an extension adapter according to the present invention view taken along line A-A in FIG. 4 (headliner removed).

FIG. 6 illustrates a cutaway view of an extension adapter according to the present invention in a perspective view of a sunroof mechanism arm taken along lines A-A in FIG. 4 (headliner removed).

FIG. 7 illustrates a prior art sunroof mechanism arm in an exploded view without an extension adapter according to the present invention.

FIG. 8 illustrates a prior art sunroof mechanism arm in a perspective view without an extension adapter according to the present invention.

FIG. 9 illustrates a sunroof installed in a vehicle without an extension adapter according to the present invention.

FIG. 10 illustrates a cross sectional view of an installed sunroof without an extension adaptor of the present invention taken along line B-B in FIG. 9.

FIG. 11 illustrates a perspective view of one embodiment of an extension adapter of the present invention.

FIG. 12 illustrates a perspective view of an alternate shape of an extension adapter of the present invention.

FIG. 13 illustrates a perspective view of an alternate shape of an extension adapter of the present invention.

### DETAILED DESCRIPTION OF THE INVENTION

The present invention provides a movable surface mounting bracket extension adapter to allow greater flexibility of vertical sunroof adjustment relative to a sunroof mechanism during installation. The present invention allows application of a single sunroof assembly module to a greater range of vehicle applications and a greater range of vehicle roof sweeps (curves) and movable panel sweeps. While the present invention is described in terms of a glass sunroof application for a motor vehicle, it is understood that the scope of the present invention is intended to cover all movable surfaces in any application where a flush fit is desired relative to adjacent supporting structure.

The need for greater flexibility of the vertical adjustment of a sunroof relative to a sunroof module is evident by the greater demand for standardization of a sunroof module that can be applied to greater variations of applications. For example, there are great variations of the front to back and side to side sweep of different vehicle roofs. A sunroof module that houses all the components of a typical contemporary motorized sunroof is manufactured to be attached on the inside of the vehicle roof at fairly typical points along its periphery as allowed by sound engineering practices. Naturally, the greater the curve of the roof, the lower the module would be attached relative to the crown of the curve. Since the module sits lower in this situation, the edge of the sunroof glass would meet the opening of the vehicle in a lower position as well. It is desirable, if not necessary, for aesthetics and aerodynamics to position the edge of the glass sunroof flush with the roof.

It is also desirable for a sunroof module manufacturer to limit the amount of customization needed to accommodate the widest variety of contemporary vehicle roof sweep variations. In current module designs, slight variations are possible, but large variations are not possible without potentially compromising strength and integrity of the module. The present invention allows for greater variation of the vertical height of sunroof glass relative to its module.

The additional variation of the present invention is accomplished by providing extension adapters configured to be attached, if needed, between the sunroof mechanism arms and the glass panel attachment tabs on the mounting bracket for sunroof. The extension adapters are configured so as not to interfere with the function of the mechanism arms used to move and tilt the sunroof. The adapters have apertures to attach to the mechanism arms at one end and an additional set of apertures to attach to the sunroof mounting bracket at the other. The variation of distance between the sets of holes does not affect the function of the mechanism arms. Therefore, when an application requires a variation in the amount of extension, the adapter would only need to change the dimension of the distance between the sets of holes. This is quite a savings in time and cost over the prior art in that the entire sunroof module and mechanisms do not need to be re-engineered. This provides significant cost savings and reduced development time.

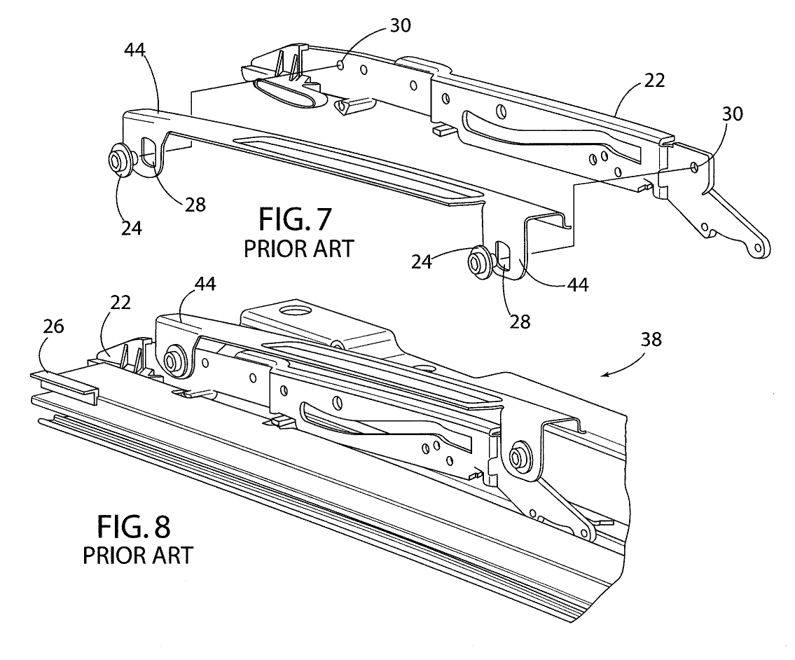

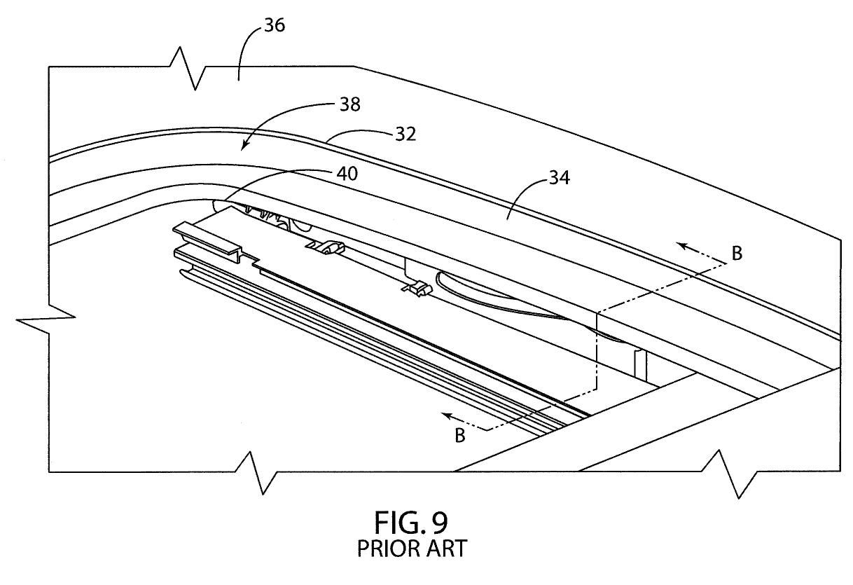

Turning now to figures, FIGS. 7-10 show a prior art sunroof mechanism assembly that is part of an overall sunroof module. As shown in FIG. 7, a sunroof bracket 44 attaches a mechanism arm 22 by fasteners 24. The resultant assembly is shown in FIG. 8 installed in a sliding track 26. Mounting bracket 44 can be used to mount a vehicle moving surface such as a glass sunroof (not shown). Mechanism arm 22 can be placed within a sliding track 26 to provide desired movement of the sunroof such as tilting or sliding, which are both known in the art. As shown, mounting bracket 44 has openings 28 to allow fasteners 24 to pass through to fasten at point 30 on the mechanism arm. A typical fastener 24 can be a threaded screw that attaches to a threaded bore at point 30 of mechanism arm 22. The threaded portion of fastener 24 passing through opening 28 is smaller in diameter than opening 28 by, for example, about 2-4 mm. This allows small adjustments to the position of mounting bracket 44 relative to mechanism arm 22. These adjustments become useful during the installation of a sunroof module to a roof of a vehicle to assure a flush fit of the sunroof, when attached to mounting bracket 44, relative to a rim 32 of an opening 34 of a vehicle roof 36 (see FIG. 9).

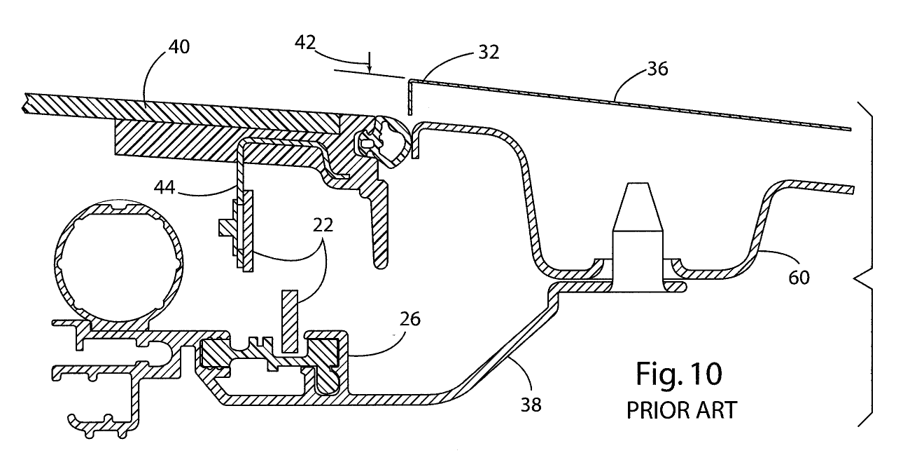

As illustrated in FIGS. 9 and 10, a sunroof module 38 is installed on a vehicle in a typical fashion known in the art. Module 38 is attached to roof 36 by a roof bracket 60 by a sunroof module mounting pin 62. However, as illustrated at 42, glass sunroof 40 is not flush with rim 32 of roof 36 when mounted to the roof bracket. As discussed above, this variance can be created by a significant increase in the sweep of the roof relative of prior applications designed for installing a given module. In the art a +/−2 mm variance in the height of the sunroof 40 relative to the roof 36 is acceptable. However, as illustrated in FIG. 10, the cross sectional line taken along line B-B of FIG. 9 shows the variance at an unacceptable level at 42 by, for example, 11 mm. In the past, the alternative in the art was to redesign the sunroof module to overcome a variance that could not be corrected to within +/−2 mm flush out variance using mounting bracket opening 28 variance. This adds considerable cost to an application and delay in production. Further as roof sweeps increase, the redesign of the sunroof module 38 cannot overcome these variances.

The present invention provides a quick and easy solution to correct for large flush out variance among many various automotive roof designs while using the same sunroof module 38 without modification. In general, this is accomplished through the addition of an adapter that can be easily developed and adapted for insertion between the sunroof mounting bracket 44 and mechanism arm 22 without adversely affecting performance or integrity of the sunroof module.

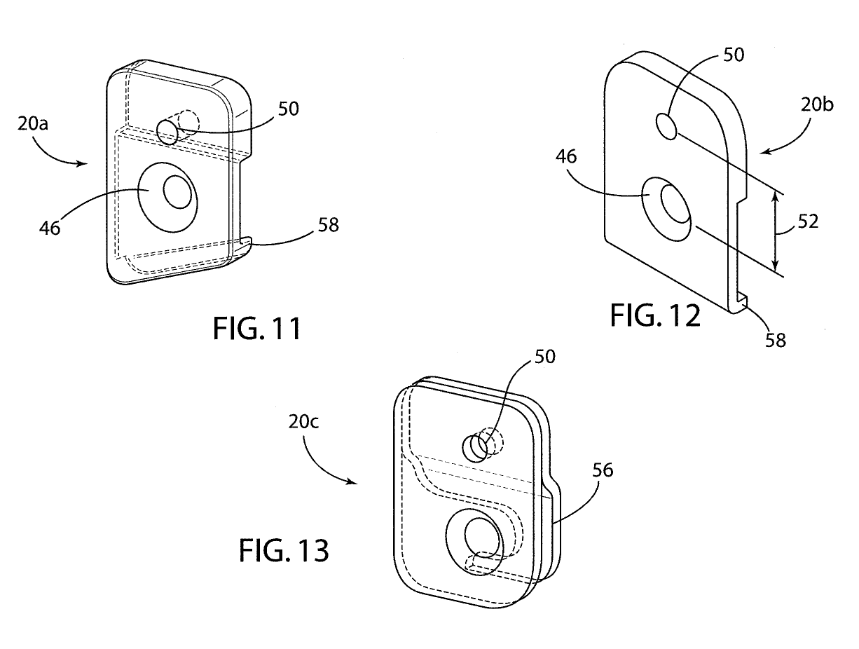

Various embodiments of the present invention adapter 20 are shown in FIGS. 11-13 and generally indicated as adapter 20a, 20b, and 20c respectively. Adapter 20 can have a countersunk opening 46 configured to accept a flat head screw 48 to attach to fastening point 30 of mechanism arm 22 and a second opening 50 configured to allow passage of fasteners 24 to attach to bracket 44. As shown in FIG. 12, dimension 52 is a distance to overcome the flush out variance for an application and can range from at least 3 mm to 15 mm, and even beyond to any dimension that still maintains integrity and functionality of the sunroof module. For illustrative purposes only, dimension 52 distance between openings 50 and 46 can be 10 mm, which would overcome the 11 mm flush out variance 42 shown in FIG. 10. Adapter 20 can be configured in a number of variations of sizes, shapes, and materials so long as it can be inserted between mounting bracket 44 and mechanism arm 22, while allowing full functionality and integrity of the sunroof module. Materials can be stamped sheet metal parts spot welded together, cast iron, milled iron, and the like. Materials can vary using sound engineering principles and so long as functionality and integrity of the sun roof module is maintained.

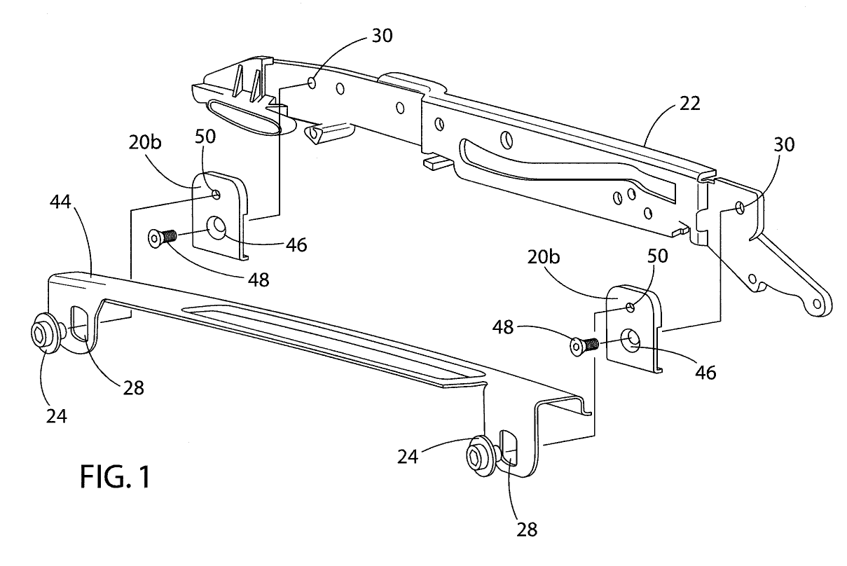

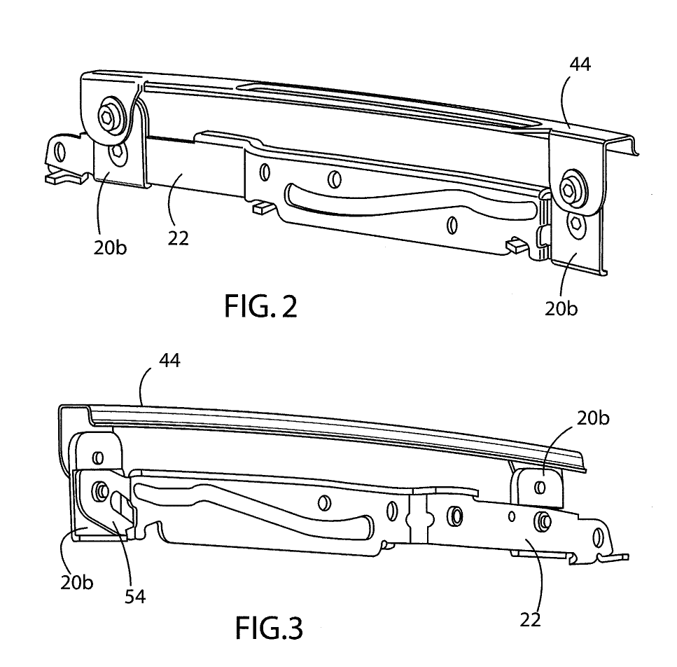

Turning to FIGS. 1-6, adapter 20b is shown in an unassembled sunroof module 38 in FIG. 1, while FIGS. 2 and 3 show adapter 20b installed and assembled. It is noted that at point 54 of FIG. 3 (the reverse angle of FIG. 2), embodiment 20a could also be used as it is contoured to match the contours of mechanism arm 22. Further, embodiment 20c could also be applied in this application. A lip 58 can add further attachment stability. Lip 58 can be developed by milling or stamping. Alternatively, the addition of adapter tab 56 could be used in applications where additional lateral support may be indicated, such as when variance dimension 52 is quite high, say for example greater than 15 mm.

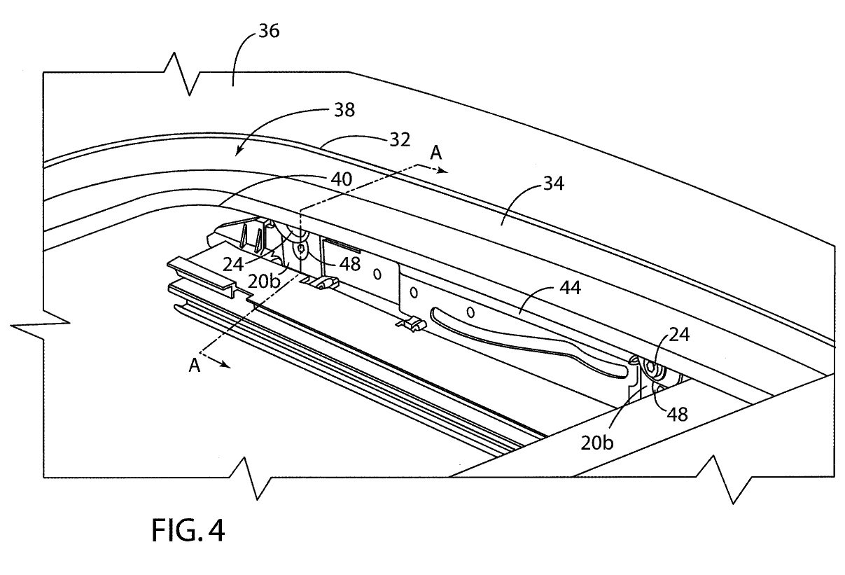

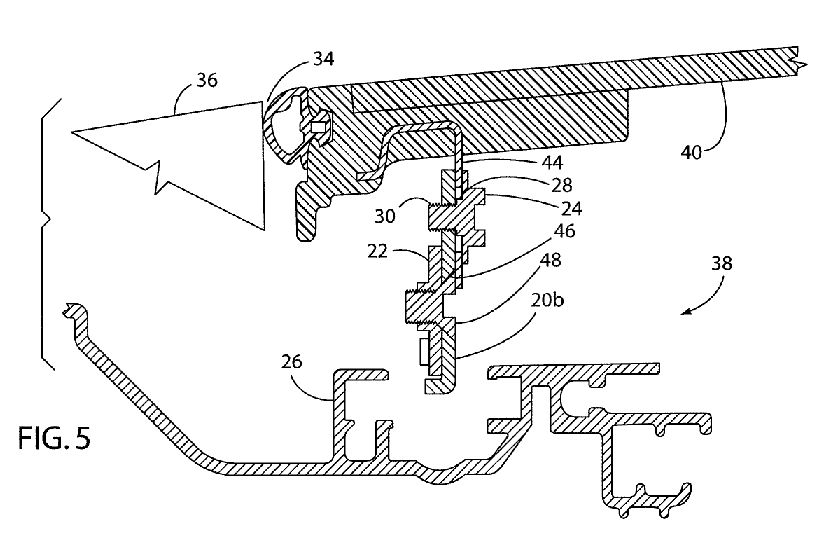

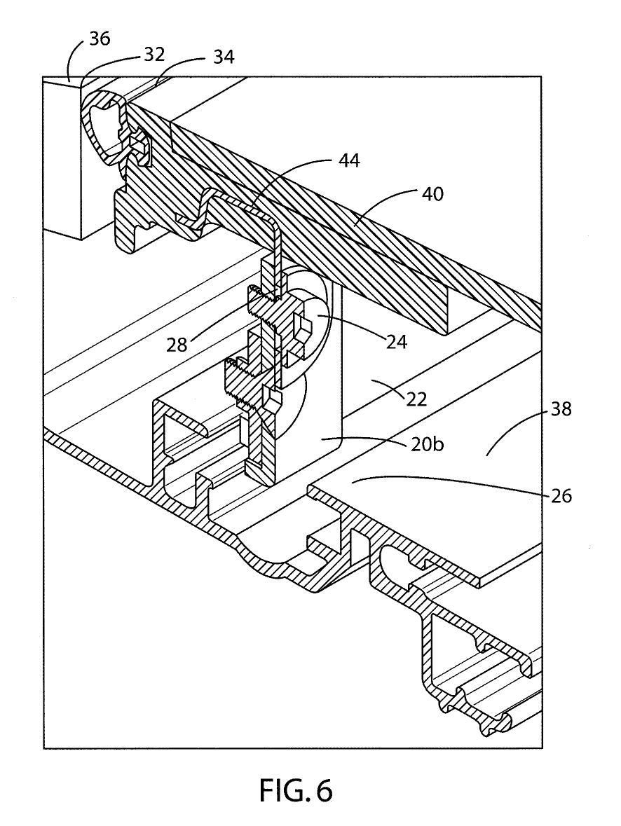

FIG. 4 shows a sunroof module 38 with adapter 20b installed in the same vehicle roof 36 shown in FIGS. 9 and 10. In contrast to FIG. 9, FIG. 4 shows the glass sunroof 40 is now flush with rim 32 of roof 36. This is more clearly shown in FIG. 5 as a sectional view taken along line A-A of FIG. 4, where the height of glass 40 is now flush with vehicle roof opening 34. Also shown in FIG. 6 is a perspective cut-away view along line A-A of FIG. 4 showing the flush installation.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims.

What is claimed is:

1. A movable surface extension adapter, comprising:
a front side, a back side, an upper portion, and a lower portion;
a countersunk first opening on the lower portion;
a second opening in the upper portion spaced a predetermined distance from the first opening to compensate for a vertical variance of the mounted movable surface to a vehicle roof; and
the bracket configured to be placed and attached between a sunroof mounting bracket and a sunroof mechanism arm, whereby function of the movable surface is maintained.

2. The bracket of claim 1, wherein the predetermined distance is a range of 3 to 15 mm.

3. The bracket of claim 1, further comprising a lip on a lower edge to conform to a lower edge of the mechanism arm.

4. The bracket of claim 1, further comprising a tab to retain the mechanism arm from a first and second side of the mechanism arm.

5. The bracket of claim 1, wherein the lower portion has a distal edge that conforms to the contour of the mechanism arm.

6. An assembly to slideably attach a movable surface to a vehicle, comprising:
a mechanism arm slideably attached to a sliding track of a sunroof module;
a bracket attached to the movable surface; and
an extension adapter, having a front side, a back side, an upper portion, and a lower portion, a countersunk first opening on the lower portion, a second opening in the upper portion spaced a predetermined distance from the first opening to compensate for a vertical variance of the mounted movable surface to a vehicle roof, and configured to be placed and attached between a sunroof mounting bracket and a sunroof mechanism arm, whereby full function of the movable surface is maintained.

7. A method of flushing out a movable surface to an adjacent opening of a top edge of a vehicle roof, comprising the steps of:
attaching a sunroof module to the roof by attaching a module mounting pin to a roof bracket, the sunroof module having a movable surface attached to a bracket, which is attached to a mechanism arm slidably retained within a module sliding track;
measuring a vertical distance of the movable surface beneath below the roof top edge;
inserting an extension adapter between the bracket and the mechanism arm, the extension adapter having a front side, a back side, an upper portion, and a lower portion, a countersunk first opening on the lower portion, a second opening in the upper portion spaced the vertical distance from the first opening to compensate, whereby full function of the movable surface is maintained.

8. The method of claim 7, wherein the measuring of vertical distance is accurate to +/−2 mm.
